(19) United States
(12) Patent Application Publication
(10) Pub. No.: US 2025/0005898 A1
(43) Pub. Date: Jan. 2, 2025

(54) REPLACEMENT OF SOURCE MOVING OBJECTS WITH TARGET MOVING OBJECTS IN A VIDEO USING GAN

(71) Applicant: International Business Machines Corporation, Armonk, NY (US)

(72) Inventors: Sathya Santhar, Ramapuram (IN); Sridevi Kannan, Katupakkam (IN); Sarbajit K. Rakshit, Kolkata (IN); Samuel Mathew Jawaharlal, Chennai (IN)

(21) Appl. No.: 18/341,979

(22) Filed: Jun. 27, 2023

(51) Int. Cl. G06V 10/764; G06T 5/50; G06T 7/12; G06V 10/60

(52) U.S. Cl. CPC G06V 10/764; G06T 5/50; G06T 7/12; G06V 10/60; G06T 2207/20221

(57) ABSTRACT

One or more systems, devices, computer program products and/or computer-implemented methods provided herein relate to video editing, and more specifically, to replacement of a source moving object of a first video with a target moving object of a second video using a GAN to produce a realistic video output. In an embodiment, the GAN classifies an output video as real or fake. In another embodiment, the GAN classifies the output video based on whether the target moving object is available and the source moving object is replaced.

### BACKGROUND

The subject disclosure relates to video editing, and more specifically, to the replacement of a source moving object of a first video with a target moving object of a second video using a generative adversarial network (GAN).

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products in accordance with the present invention.

According to an embodiment, a system can comprise a memory that stores computer executable components; and a processor that executes the computer executable components stored in the memory. The computer executable components can comprise: a generative adversarial network comprising: a generator component that replaces a source moving object of a first video with a target moving object of a second video to produce an output video; and a classifier component that classifies the output video as real or fake. Additional aspects of the present disclosure are directed to systems and computer program products configured to perform the methods described above.

### DESCRIPTION OF THE DRAWINGS

FIG. 1 illustrates a block diagram of an example, non-limiting system that can facilitate replacement of a source moving object of a first video with a target moving object of a second video using GAN, in accordance with one or more embodiments described herein.

FIG. 2 illustrates another block diagram of an example, non-limiting system that can facilitate replacement of source moving object of a first video with a target moving object of a second video using GAN, in accordance with one or more embodiments described herein.

FIG. 3 illustrates another block diagram of an example, non-limiting system that can facilitate replacement of source moving object of a first video with a target moving object of a second video using GAN, in accordance with one or more embodiments described herein.

FIG. 4 illustrates another block diagram of an example, non-limiting system that can facilitate replacement of source moving object of a first video with a target moving object of a second video using GAN, in accordance with one or more embodiments described herein.

FIG. 5 illustrates another block diagram of an example, non-limiting system that can facilitate replacement of source moving object of a first video with a target moving object of a second video using GAN, in accordance with one or more embodiments described herein.

FIG. 6 illustrates another block diagram of an example, non-limiting system that can facilitate replacement of source moving object of a first video with a target moving object of a second video using GAN, in accordance with one or more embodiments described herein.

FIG. 7 illustrates a flow diagram of an example, non-limiting computer-implemented method in accordance with one or more embodiments described herein.

FIG. 8 illustrates a flow diagram of an example, non-limiting computer-implemented method in accordance with one or more embodiments described herein.

FIG. 9 illustrates a flow diagram of an example, non-limiting computer-implemented method in accordance with one or more embodiments described herein.

FIG. 10 illustrates a flow diagram of an example, non-limiting computer-implemented method in accordance with one or more embodiments described herein.

FIG. 11 illustrates a flow diagram of an example, non-limiting computer-implemented method in accordance with one or more embodiments described herein.

FIG. 12 illustrates a block diagram of an example, computing environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Video editing is the manipulation and arrangement of video shots which are used to structure and present video information, including films, television shows, video advertisements, and video essays. Editing a video can be difficult and tedious, especially when a realistic looking output video is desired. Video editing and manipulation often require a large amount of manual effort and may result in a video that is obviously edited and not appearing realistic.

Production of realistic edited videos is a difficult task even for skilled video editors. Automatic and realistic desired video manipulation and generation are required to reduce required manual tasks and increase productivity. It may be desirable to replace a source moving object in a first video efficiently and realistically with a target moving object of a second video. For example, consider a film that is being produced in multiple languages. A first lead actor may be fluent in one language and/or popular in a region using that language, but not fluent in another language and/or popular in another region. Therefore, it may be desirable to shoot a movie using two different lead actors for the same part, each speaking a different language. For various reasons, it may be impossible to accommodate both actors at a shooting location at the same time to shoot a scene for a movie. If video editing can achieve the realistic and efficient replacement of a source moving object (e.g., the first lead actor) with a target moving object (e.g., a second lead actor) while retaining the qualities of the target moving object, the entire film need not be shot twice in its entirety. Instead, the movie can be shot with only the first lead actor and the required supporting actors and sets. The second lead actor can act out only the lead actor specific portions of the movie that need to be shot and that footage can be used to replace the first lead actor in the film as originally shot. This leads to a reduction of production cost and enhances the experience of the people involved by alleviating schedule restraints.

With advances in deep learning, deep generative models can be used for video editing. These deep generative models provide a way to utilize unlabelled images and videos, since they can learn deep feature representations in an unsupervised manner. The use of generative adversarial networks (GANs) is an approach towards generative modelling using deep learning methods, such as convolutional neural networks. GANs enable training of a generative model by framing the problem as a supervised learning problem with two sub-models: the generator model that is trained to generate new examples, and a classifier model that is trained to classify examples as either real (from the domain) or fake (generated). The two models are trained together in a zero-sum game, adversarial manner until the classifier model designates generated examples as real about half of the time. Therefore, the generator model is generating plausible examples at that point. GANs have recently received an increasing amount of attention and produced promising results, especially in the tasks of new video generation and next frame prediction in a video.

GANs can generate an entirely new video (video synthesis) or can predict and generate the next frame given the current & previous frames of a video (video prediction). Although synthetic appearances are conditioned on the previous frames, future video motions are unconditionally generated, which is inappropriate for motion controllable video synthesis. With the emergence of conditional GANs, extra conditioning inputs are used to control the output image appearances. Domain transfer can also be achieved using cyclicGAN that involves generating a new synthetic version of a given image or video with a specific modification, such as translating the landscape or an object in a video. The generated image or video can be a season translation, object transfiguration, or style transfer.

GANs can synthesize highly convincing images and voices and can even swap a person's face onto a video clip. Known techniques, however, lag in natural video generation. Manipulation of a moving object in a video remains a challenging task. Generative models are capable of generating still images with high fidelity, but have struggled to produce realistic video outputs. According to embodiments of the present invention, the image generation capability can be translated into generation of high-resolution videos. Cutting a specific moving object from a video and replacing the cut object with another moving object from a different video to generate realistic results is desirable, however, a problem exists in generating a natural video with no traces of cut and replacement to the original video. Further, it is desirable that the source object be completely replaced with the target object, and that the target object be allowed to maintain its characteristics (e.g., movements).

According to an embodiment, a GAN can detect and segment out prominent (conditioned) objects in a video and train the system without any direct supervision on object detection or segmentation for the detection and segmentation in the future frames. A generator copies a moving object from the video into another video by replacing the source content with the target content in an attempt to have a classifier classify the generated video as real about half of the time. Therefore, the generator must learn to discover and copy the target objects throughout the video, since the video will otherwise appear fake. The input is not conditioned with motion or appearance. Replacement of a source moving object of a first video with a target moving object of a second video can be achieved while retaining the originality of the target object in the first video with a natural effect.

A difference between a standard GAN and an embodiment of the present invention is in a way the generator produces the generated (“fake”) video. Rather than directly outputting the pixels, the GAN combines two videos (source and destination) by copying and removing a mobile object from the source video and replacing another mobile object with it into the ‘destination’ video. Given conditioning input of a source object in a video and target object in another video, a new video can be synthesized with the source moving object of the first video replaced by the target moving object of the second video. Both the videos are further divided into object (e.g., human) and background appearances where the background appearance of the original video is retained by only replacing the object.

By way of overview, aspects of systems apparatuses or processes in accordance with the present invention can be implemented as machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however in various cases, that the one or more embodiments can be practiced without these specific details. As used herein, the term “entity” can refer to a machine, device, component, hardware, software, smart device and/or human.

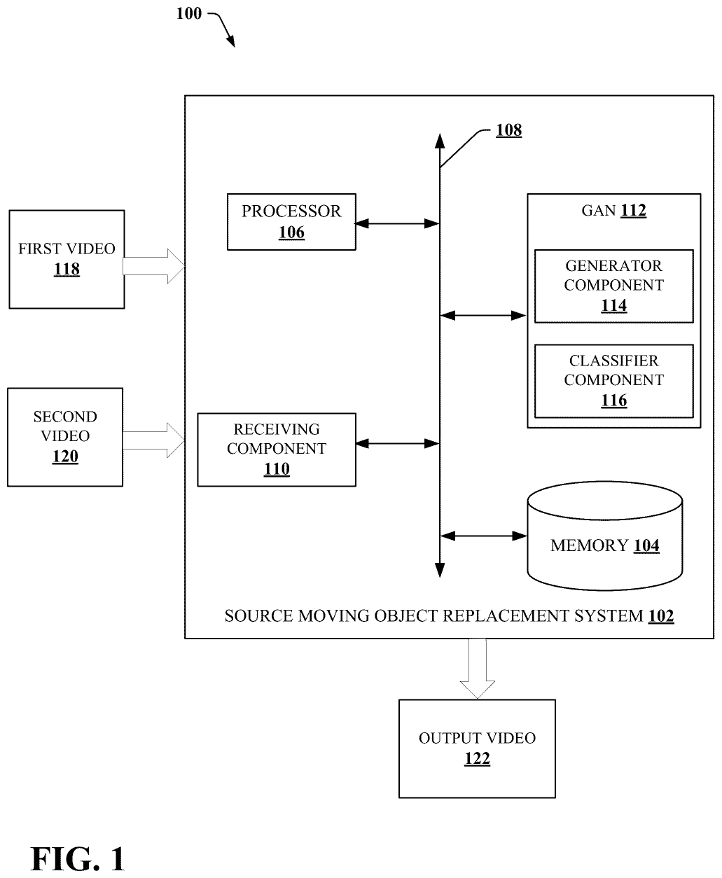

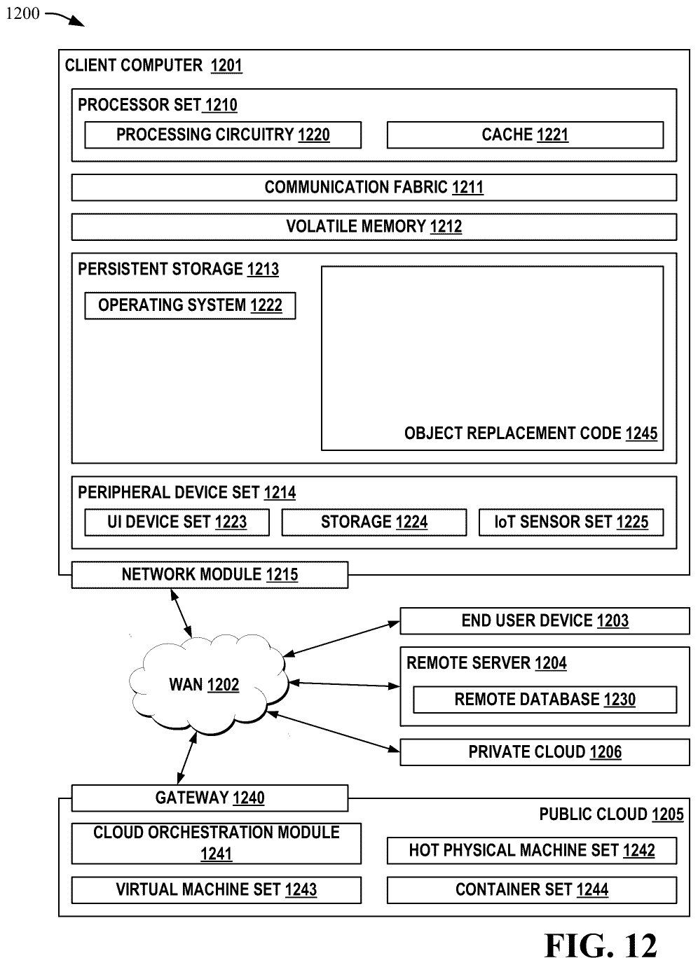

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 100-600 as illustrated at FIGS. 1-6, and/or systems thereof, can further comprise, be associated with and/or be coupled to one or more computer and/or computing-based elements described herein with reference to an operating environment, such as the operating environment 1200 illustrated at FIG. 12. In one or more described embodiments, computer and/or computing-based elements can be used in connection with implementing one or more of the systems, devices, components and/or computer-implemented operations shown and/or described in connection with FIGS. 1-6 and/or with other figures described herein.

FIG. 1 illustrates a block diagram of an example, non-limiting source moving object replacement system 102 that facilitates replacement of a source moving object of a first video with a target moving object of a second video using a GAN in accordance with one or more embodiments described herein. As illustrated at FIG. 1, the source moving object replacement system 102 can comprise one or more components, such as a memory 104, processor 106, bus 108, receiving component 110, GAN 112, generator component 114, and/or classifier component 116. Generally, source moving object replacement system 102 can facilitate replacement of a source moving object of a first video 118 with a target moving object of a second video 120 in a video using a GAN to produce a realistic output video 122. The output video 122 comprises the target moving object replacing the source moving object in the first video 118. The target moving object can retain its characteristics, such as the movements exhibited in the second video 120. The output video 122 can comprise a background and other objects of the first video 118. For example, the output video can comprise a set with supporting actors as depicted in the first video 118 and a second lead actor depicted in the second video 120, wherein the second lead actor is replacing the first lead actor in the output video 122. The source moving object and the target moving object can also be non-human objects.

The receiving component 110 can receive a first video 118 and a second video 120. The first video 118 comprises a first moving object and the second video 120 comprises a second moving object. The first moving object can be a source moving object and the second moving object can be a target moving object. For example, the first video can comprise footage of a first actor performing a script in a first language and the second video can comprise footage of a second actor performing the script in a second language. The first video and the second video can be a whole or a part of a film, television show, a video advertisement, or other type of video.

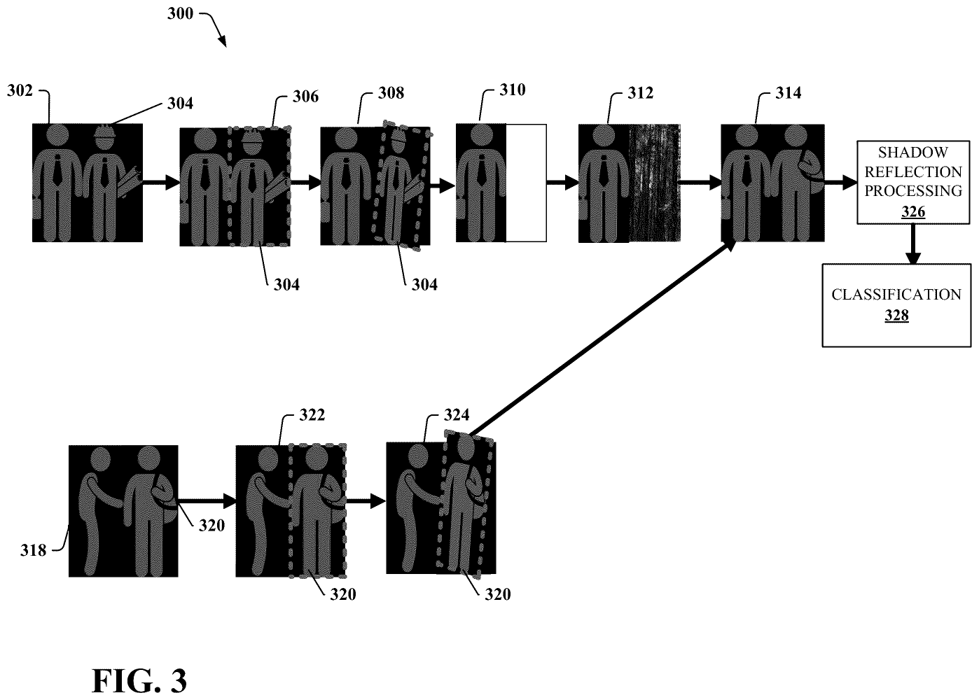

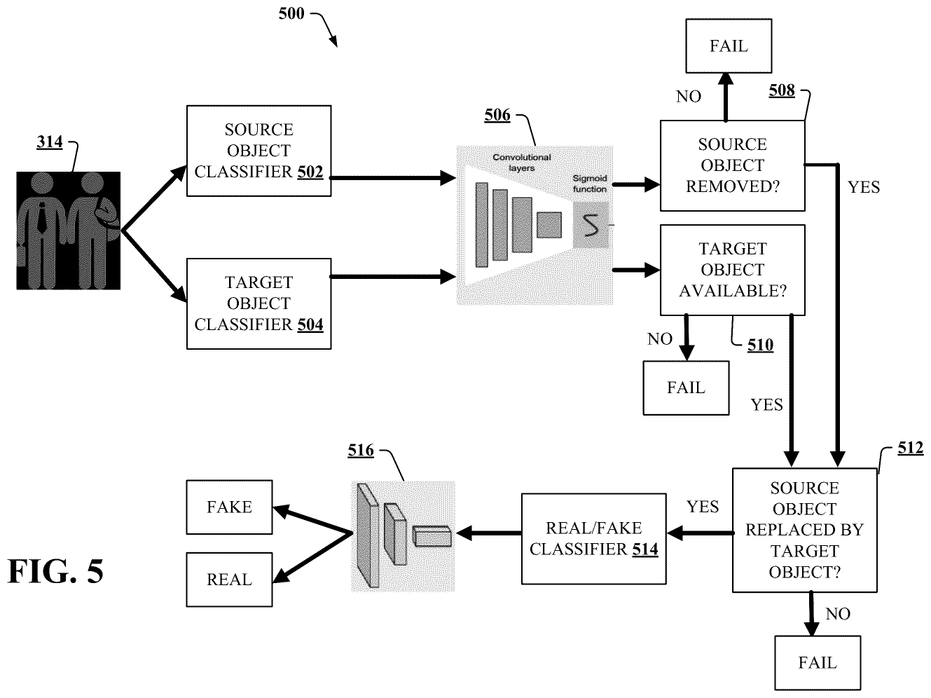

The GAN 112 can comprise the generator component 114 and the classifier component 116. The generator component 114 can replace a source moving object of a first video with a target moving object of a second video to produce an output video. Operations of the generator component 114 are described in further detail with reference to FIG. 3 below. The classifier component 116 can classify the output video 122 as real or fake. Operations of the classifier component 116 are described in further detail with reference to FIG. 5 below.

The various devices (e.g., system 100) and components (memory 104, processor 106, receiving component 110, GAN 112, generator component 114, classifier component 116 and/or other components) of system 100 can be connected either directly or via one or more networks. Such networks can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

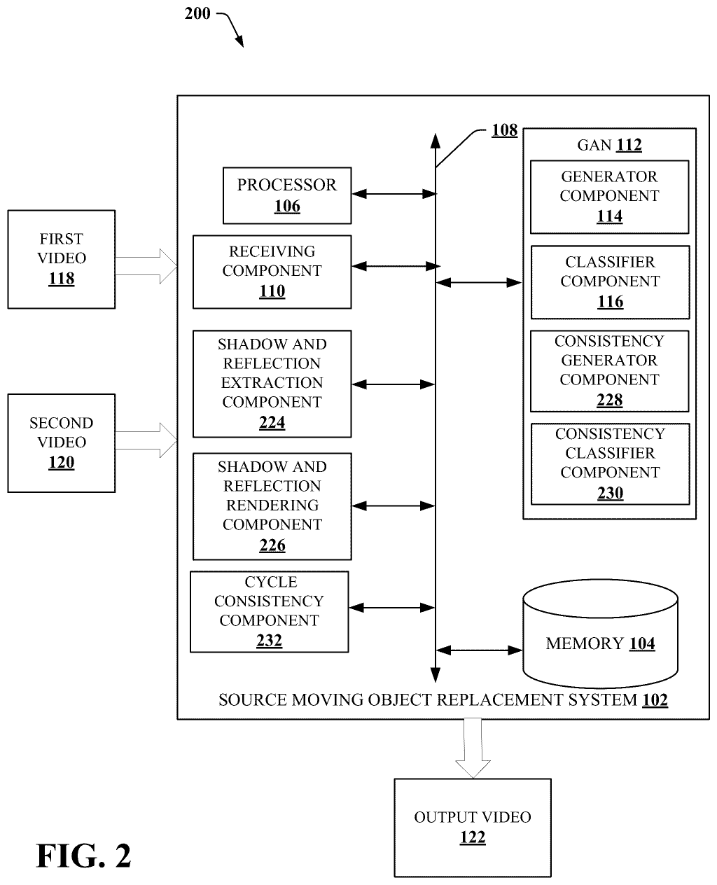

FIG. 2 illustrates a block diagram of an example, non-limiting system 200 that facilitates replacement of a source moving object of a first video with a target moving object of a second video using a GAN in accordance with one or more embodiments described herein. Repetitive description of like elements and/or processes employed in respective embodiments is omitted for sake of brevity. As indicated previously, description relative to an embodiment of FIG. 1 can be applicable to an embodiment of FIG. 2. Likewise, description relative to an embodiment of FIG. 2 can be applicable to an embodiment of FIG. 1.

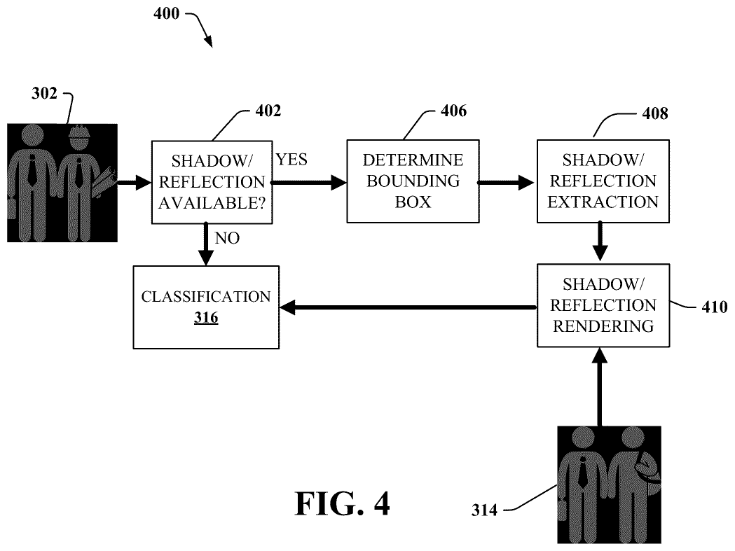

The system 200 comprises a shadow and reflection extraction component 224. The shadow and reflection extraction component 224 can determine whether at least one of a reflection and a shadow of the moving source object exist in the first video 118, and in response to a determination that at least one of a reflection and a shadow of the moving object exist in the first video 118, removes the at least one of the reflection and the shadow from the first video 118. For example, a first video 118 could comprise a first lead actor performing a script in front of a mirror. In this example, the first lead actor can be the source moving object. The shadow and reflection component 224 can detect that the first video 118 comprises a reflection of the first lead actor (the source moving object) in the mirror. The shadow and reflection extraction component 224 can further extract the reflection of the first lead actor from the first video 118. In an embodiment, the shadow and reflection component can detect and extract the reflection or shadow of a source moving object from the first video 118 using bounding boxes. Operations of the shadow and reflection extraction component 224 are described in further detail with reference to FIG. 4 below.

The system 200 comprises a shadow and reflection rendering component 226. The shadow and reflection rendering component 226 can, in response to a determination that at least one of a reflection and a shadow of the source moving object exist in the first video 118, renders corresponding reflections and shadows of the moving target object in the first video 118. For example, the shadow and reflection rendering component 226 can, in response to a determination by the shadow and reflection extraction component 224 that there exists a reflection of a first lead actor in the first video 118, render a corresponding reflection for a second lead actor to be inserted in the first video 118. In an embodiment, the shadow and reflection rendering component 226 can insert a rendered reflection or shadow of a target moving object into the first video 118 at a corresponding location within the first video 118 to the location of the reflection or shadow of the source moving object. In an embodiment, the shadow and reflection rendering component 226 determines the corresponding location based on bounding boxes associated with the shadow or reflection of the source moving object within the first video 118. Operations of the shadow and reflection rendering component 226 are described in further detail with reference to FIG. 4 below.

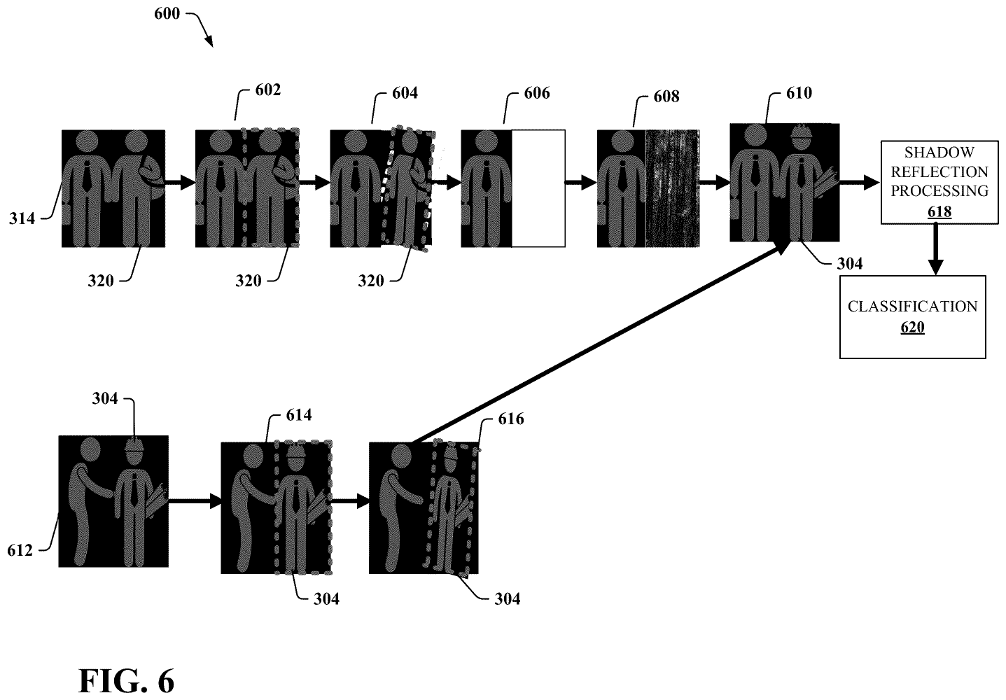

The system 200 further comprises a GAN 112 comprising a consistency generator component 228. The consistency generator component 228 can replace the moving target object of the output video 122 with a removed moving source object of the first video to produce a consistency output video. The GAN 112 further comprises consistency classifier component 230 classifies the consistency output video as real or fake. A video output by the generator component 114 (output video 122) can be used as input for a second generator such as the consistency generator component 228 (e.g., as a video corresponding to the first video 118 to the generator component 114). In an embodiment, the consistency generator component 228 can produce a consistency output video wherein the target moving object of output video 122 is replaced with the source moving object of the first video 118. The consistency generator component 228 may obtain the source moving object from the first video 118 or another video comprising the source moving object. If the system is producing realistic examples, the consistency output video should match the first video 118 exactly or very closely. A comparison of the consistency output video and the first video 118 can generate a consistency loss, which can be used to train classifier component 116. In an embodiment, the consistency output video could be used as input to the generator component 114 to generate another measure of consistency loss. Operations of a cyclicGAN is described in further detail below with reference to FIG. 6.

The system 200 further comprises a cycle consistency component 232. The cycle consistency component 232 compares the first video to the consistency output video to generate a cycle consistency loss. In an embodiment, the cycle consistency component 232 can transmit information related to the cycle consistency loss to classifier component 116 to improve classification of output videos such as output video 122.

FIG. 3 illustrates a block diagram of an example, non-limiting system 300 that facilitates replacement of a source moving object of a first video with a target moving object of a second video using a GAN, in accordance with one or more embodiments described herein. Repetitive description of like elements and/or processes employed in respective embodiments is omitted for sake of brevity. As indicated previously, description relative to an embodiment of FIGS. 1 and 2 can be applicable to an embodiment of FIG. 3. Likewise, description relative to an embodiment of FIG. 3 can be applicable to an embodiment of FIGS. 1 and 2.

The system 300 comprises a first video 302 comprising a source moving object 304. The receiving component 110 can receive the first video 302. In an example, the first video 302 can comprise a first actor speaking a first language in a scene of a film. The generator component can identify and locate the source moving object. The identified and located source moving object 304 is depicted at 306. In an embodiment, the identification of the source moving object 304 can be based on user input. In an embodiment, the generator component 114 can identify and locate the source moving object 304 based on machine learning techniques. In an embodiment, the generator component 114 can locate the source moving object 304 within video frames of the first video 302 via a mask R-CNN. The generator component can determine bounding box coordinates for the source moving object 304 corresponding to a plurality of video frames of the first video 302.

The receiving component 110 can further receive a second video 318 comprising a target moving object 320. In an example, the second video 318 can comprise a second actor speaking a second language in a scene of a film. The generator component 114 can identify and locate the target moving object 320 as depicted at 322 of FIG. 3. In an embodiment, the identification of the target moving object 320 can be based on user input. In an embodiment, the generator component can identify and locate the target moving object 320 based on machine learning techniques. In an embodiment, the generator component 114 can locate the target moving object 318 within video frames of the second video 318 via a mask R-CNN. The generator component can determine bounding box coordinates for the target moving object 320 corresponding to a plurality of video frames for the second video 318.

At 308, the source moving object 304 is segmented and removed. In an embodiment, the source moving object 304 is segmented and removed from the first video 302 by the generator component 114. In an embodiment, the generator component 114 removes the segmented source moving object 304 from the first video 302 using a binary mask to generate a masked out first video 310.

At 324, the target moving object 320 is segmented and removed. In an embodiment, the target moving object 320 is segmented and removed from the second video 318 by the generator component 114. In an embodiment, the generator component 114 removes the segmented target moving object 318 from the second video 318 using a binary mask.

At 312, the masked out first video 310 is in-painted to produce an in-painted version of the first video after the source moving object is removed from it. In an embodiment, the generator component 114 in-paints the masked out first video 310 to produce an in-painted first video 312.

At 314, a composite video is produced by combining the in-painted first video and the removed target moving object 320 from the second video 318 so that the source moving object 304 of the first video 302 is replaced with the target moving object 320 of the second video 318. In an embodiment, the generator component 114 combines the in-painted first video 312 and the removed target moving object 320 to produce an output video 314. For example, the generator component 114 can combine the in-painted first video 312 and the removed target moving object 320 via a paste operation using standard alpha compositing. In an embodiment, the generator component 114 can paste the target moving object 320 in the in-painted first video 312 at the location of the source moving object 304 based on the bounding box coordinates of the source moving object 304 in the first video 302.

At 326, the output video 314 can be subject to shadow and reflection processing such as by shadow and reflection extraction component 224 and shadow and reflection rendering component 226. Shadow and reflection processing is described in further detail with reference to FIG. 4 below. At 328, the output video 314 can be subject to classification such as by classification component 116. Classification of the output video is described in further detail with reference to FIG. 5 below.

FIG. 4 illustrates a block diagram of an example, non-limiting system 400 that facilitates replacement of a source moving object of a first video with a target moving object of a second video using a GAN, in accordance with one or more embodiments described herein. Repetitive description of like elements and/or processes employed in respective embodiments is omitted for sake of brevity. As indicated previously, description relative to an embodiment of FIGS. 1-3 can be applicable to an embodiment of FIG. 4. Likewise, description relative to an embodiment of FIG. 4 can be applicable to an embodiment of FIGS. 1-3.

At 402 of the system 400, the first video 302 is examined to determine whether a shadow or a reflection of the source moving object 304 is available in the first video. If not, no further shadow and reflection processing is required and the output video 314 can proceed to classification. If yes, at 406 a bounding box of the shadow or reflection is determined. In an embodiment, the shadow and reflection extraction component 224 can determine the bounding box of the shadow or reflection in the first video. At 408, the shadow and reflection extraction component can further extract the shadow or reflection of the source moving object from the first video 302. At 410, a corresponding shadow or reflection of the target moving object 320 can be rendered in the output video 314 based on the bounding box coordinates of the shadow or reflection of the source moving object 304 in the first video 302. In an embodiment, the shadow and reflection rendering component 226 can render the shadow or reflection of the target moving object 320 in the output video 314. The rendering of the shadow or reflection of the target moving object 320 can be based on an existing shadow and reflection rendering algorithm based on a shadow or reflection detection value and the corresponding bounding box coordinates of the shadow or reflection of the source moving object 304 in the first video 302.

The extraction of shadows and reflections of the source moving object 304 and the rendering of shadows and reflections of the target moving object 320 facilitate generation of a realistic edited video. The described shadow and reflection processing allows the output video 314 to maintain its characteristics except for the replacement of the source moving object 304 with the target moving object 320. Further, the target moving object 320 retains its characteristics within the output video 314.

FIG. 5 illustrates a block diagram of an example, non-limiting system 500 that facilitates replacement of a source moving object of a first video with a target moving object of a second video using a GAN, in accordance with one or more embodiments described herein. Repetitive description of like elements and/or processes employed in respective embodiments is omitted for sake of brevity. As indicated previously, description relative to an embodiment of FIGS. 1-4 can be applicable to an embodiment of FIG. 5. Likewise, description relative to an embodiment of FIG. 5 can be applicable to an embodiment of FIGS. 1-4.

The system 500 illustrates classification of an output video 314 such as by classification component 116. In an embodiment, classification component 116 can comprise a source object classifier 502 and a target object classifier 504. The source object classifier 502 can determine whether a source moving object 304 is present in an output video 314. The target object classifier 504 can determine whether a target moving object 320 is present in an output video 314. For example, the source object classifier 502 and the target object classifier 504 can determine whether the source moving object 304 and the target moving object 320 are present in the output video 314 via a neural network 506. If the source moving object 304 is not removed from the output video 314, the output video 314 fails to represent a desired output video. A desired output video can comprise a realistic replacement of a first moving object 304 with a target moving object 320. If the target moving object 320 is not present in the output video 314, the output video 314 fails to represent the desired output video. If the target moving object 320 does not replace the source moving object 304, the output video fails to represent the desired output video.

The real/fake classifier 514 classifies whether the generated output video 314 is real or fake. The real/fake classifier can comprise a neural network 516. The classification can be based on the determinations of the source object classifier 502 and the target object classifier 504 and the quality of the video. In an embodiment, the real/fake classifier 514 can classify each frame of the output video 314. In an embodiment, the real/fake classifier 514 can be constantly updated. In an embodiment, the real/fake classifier 514 can be trained and updated based on a cycle consistency loss and associated information.

FIG. 6 illustrates a block diagram of an example, non-limiting system 600 that facilitates replacement of a source moving object of a first video with a target moving object of a second video using a GAN, in accordance with one or more embodiments described herein. Repetitive description of like elements and/or processes employed in respective embodiments is omitted for sake of brevity. As indicated previously, description relative to an embodiment of FIGS. 1-5 can be applicable to an embodiment of FIG. 6. Likewise, description relative to an embodiment of FIG. 6 can be applicable to an embodiment of FIGS. 1-5.

The system 600 facilitates usage of a cyclicGAN architecture to achieve a realistic edited output video. For example, the cyclic GAN architecture can comprise two generator components and two classification components (e.g., generator component 114, consistency generator component 228, classifier component 116, and consistency classifier component 230). The consistency generator component 228 can have capacity to function in the same manner as generator component 114. The consistency classifier component can have capacity to operate in the same matter as classifier component 116. In an embodiment, output video 314 that comprises the target moving object 320 which replaces the source moving object 304 can be the output video from generator component 114 and classifier component 116. In an embodiment, the output video 314 can be a first input video to the consistency generator component 228.

The system 600 comprises the output video 314 comprising the target moving object 320. At 602, the target moving object 320 is identified and located. In an embodiment, the identification of the target moving object 320 can be based on user input. In an embodiment, the consistency generator component 228 can identify and locate the target moving object. For example, the consistency generator component 228 can locate the target moving object within video frames of the output video 314 via a mask R-CNN. The consistency generator component 228 can determine bounding box coordinates for the target moving object 320 corresponding to the video frames of the output video 314.

The system 600 can further comprise a third video 612 comprising the source moving object 304. For example, the third video 612 can comprise a combination of the second video 318 with the source moving object 304 of the first video 302. For example, the third video 612 can be the first video 302. At 614, the source moving object 304 is identified and located. In an embodiment, the identification of the source moving object 304 can be based on user input. In an embodiment, the consistency generator component 228 can identify and locate the source moving object 304. For example, the consistency generator component 228 can locate the source moving object 304 within video frames of the third video 612 via a mask R-CNN. The consistency generator component 228 can determine bounding box coordinates for the source moving object 304 corresponding to the video frames of the third video 612.

At 604, the target moving object 320 is segmented and removed. In an embodiment, the target moving object 320 is segmented and removed from the output video 314 by the consistency generator component 228. In an embodiment, the consistency generator component 228 removes the segmented source moving object 320 from the output video 314 using a binary mask to generate a masked out output video 606.

At 616, the source moving object 304 is segmented and removed. In an embodiment, the source moving object 304 is segmented and removed from the third video 612 by the consistency generator component 228. In an embodiment, the consistency generator component 228 removes the segmented source moving object 304 from the third video 612 using a binary mask.

At 608, the masked out first video 606 is in-painted to produce an in-painted version of the output video after the target moving object 620 is removed from it. In an embodiment, the consistency generator component 228 in-paints the masked out first video 606 to produce an in-painted first video 608.

A consistency video 610 is produced by combining the in-painted output video 608 and the removed source moving object 304 from the third video 610 so that the target moving object 320 of the output video 314 is replaced with the source moving object 304 of the third video 610. In an embodiment, the consistency generator component 228 combines the in-painted output video 608 and the removed source moving object 304 to produce a consistency output video 610. For example, the consistency generator component 228 can combine the in-painted output video 608 and the removed source moving object 304 via a paste operation using standard alpha compositing. In an embodiment, the consistency generator component 228 can paste the source moving object 304 in the in-painted output video 608 at the location of the target moving object 320 based on the bounding box coordinates of the target moving object 320 in the output video 314.

At 618, the consistency video 610 can be subject to shadow and reflection processing such as by shadow and reflection extraction component 224 and shadow and reflection rendering component 226. At 620, the consistency output video 610 can be subject to classification such as by consistency classification component 230. Classification by the consistency classification component 230 can operate in a similar manner to that of classification component 116.

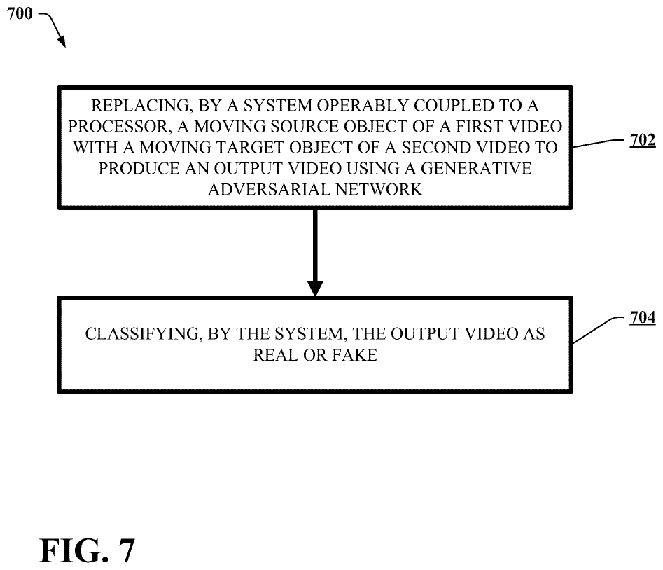

FIG. 7 illustrates a flow diagram of an example, non-limiting method 700 that can facilitate replacement of a source moving object of a first video with a target moving object of a second video using a GAN, such as in the non-limiting system 100 of FIG. 1. While the non-limiting method 700 is described relative to the non-limiting system 100 of FIG. 1, the non-limiting method 700 can be applicable also to other systems described herein. Repetitive description of like elements and/or processes employed in respective embodiments is omitted for sake of brevity. At 702, the non-limiting method 700 can comprise replacing, by a system operably coupled to a processor, (e.g., generator component 114) a moving source object of a first video with a moving target object of a second video to produce an output video using a generative adversarial network. At 704, the non-limiting method 700 can comprise classifying, by the system (e.g., classifier component 116) the output video as real or fake.

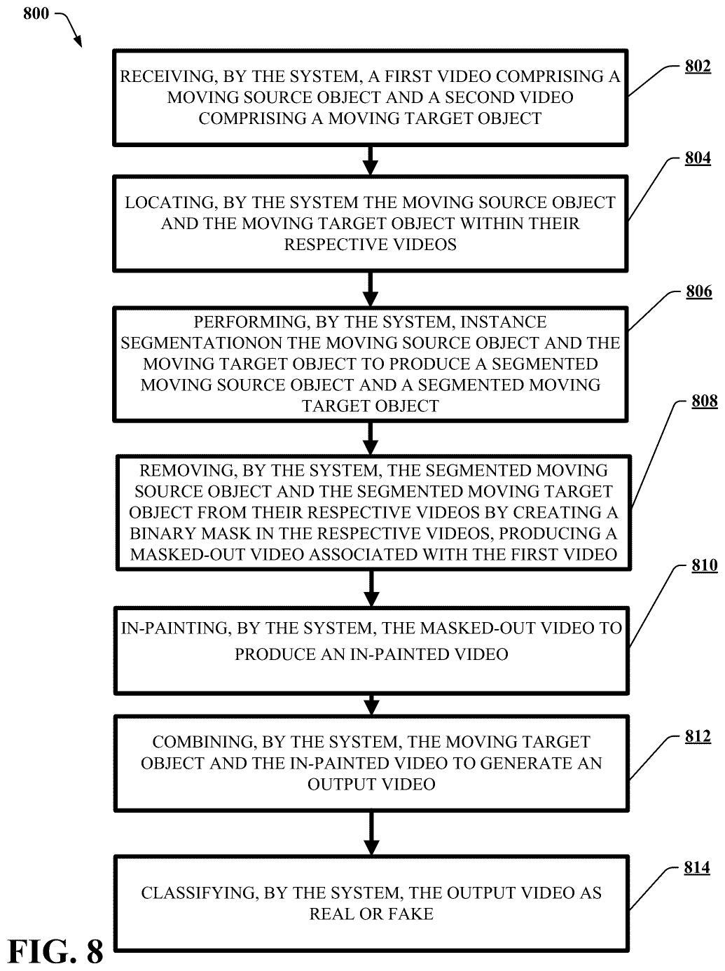

FIG. 8 illustrates a flow diagram of an example, non-limiting method 800 that can facilitate replacement of a source moving object of a first video with a target moving object of a second video using a GAN, such as in the non-limiting system 100 of FIG. 1. While the non-limiting method 800 is described relative to the non-limiting system 100 of FIG. 1, the non-limiting method 800 can be applicable also to other systems described herein. Repetitive description of like elements and/or processes employed in respective embodiments is omitted for sake of brevity. At 802, the non-limiting method 800 can comprise receiving, by a system operably coupled to a processor, (e.g., receiving component 110) a first video comprising a moving source object and a second video comprising a moving target object. At 804, the non-limiting method 800 can comprise locating, by the system, (e.g., generator component 114) the moving source object and the moving target object within their respective videos. At 806, the non-limiting method 800 can comprise performing, by the system, (e.g., generator component 114) instance segmentation on the moving source object and the moving target object to produce a segmented moving source object and a segmented moving target object. At 808, the non-limiting method 800 can comprise removing, by the system, (e.g., generator component 114) the segmented moving source object and the segmented moving target object from their respective videos by creating a binary mask in the respective videos, producing a masked-out video associated with the first video. At 810, the non-liming method 800 can comprise in-painting, by the system, (e.g., generator component 114) the masked-out video to produce an in-painted video. At 812, the non-limiting method 800 can comprise combining, by the system, (e.g., generator component 114) the moving target object and the in-painted video to generate an output video. At 814 the non-limiting method 800 can comprise classifying, by the system, (e.g., classifier component 116) the output video as real or fake.

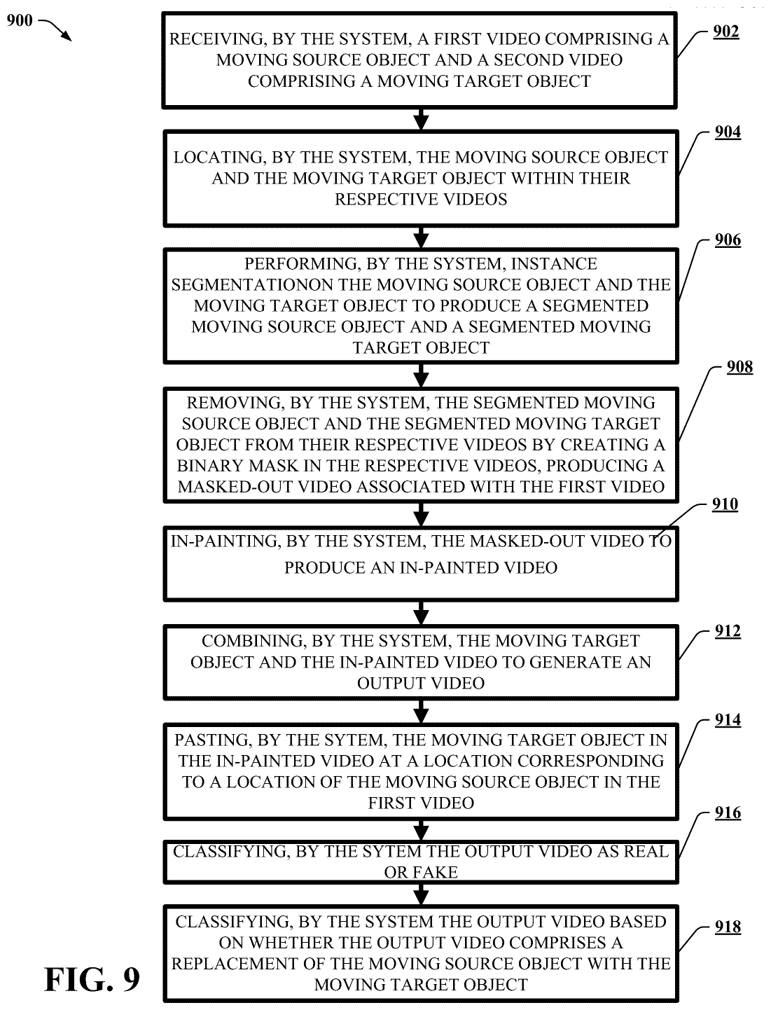

Next. FIG. 9 illustrates a flow diagram of an example, non-limiting method 900 that can facilitate replacement of a source moving object of a first video with a target moving object of a second video using a GAN in accordance with one or more embodiments described herein, such as the non-limiting system 100 of FIG. 1. While the non-limiting method 900 is described relative to the non-limiting system 100 of FIG. 1, the non-limiting method 900 can be applicable also to other systems described herein, such as the non-limiting system 100 of FIG. 1. Repetitive description of like elements and/or processes employed in respective embodiments is omitted for sake of brevity. At 902, the non-limiting method 900 can comprise receiving, by a system operably coupled to a processor, (e.g., receiving component 110) a first video comprising a moving source object and a second video comprising a moving target object. At 904, the non-limiting method 900 can comprise locating, by the system, (e.g., generator component 114) the moving source object and the moving target object within their respective videos. At 906, the non-limiting method 900 can comprise performing, by the system, (e.g., generator component 114) instance segmentation on the moving source object and the moving target object to produce a segmented moving source object and a segmented moving target object. At 908, the non-limiting method 900 can comprise removing, by the system, (e.g., generator component 114) the segmented moving source object and the segmented moving target object from their respective videos by creating a binary mask in the respective videos, producing a masked-out video associated with the first video. At 910, the non-liming method 900 can comprise in-painting, by the system, (e.g., generator component 114) the masked-out video to produce an in-painted video. At 912, the non-limiting method 900 can comprise combining, by the system, (e.g., generator component 114) the moving target object and the in-painted video to generate an output video. At 914, the non-limiting method 900 can comprise pasting, by the system, (e.g., generator component 114) the moving target object in the in-painted video at a location corresponding to a location of the moving source object in the first video. At 916, the non-limiting method 900 can comprise classifying, by the system (e.g., classifier component 116) the output video as real or fake. At 918, the non-limiting method 900 can comprise classifying, by the system (e.g., classifier component 116) the output video based on whether the output video comprises a replacement of the moving source object with the moving target object.

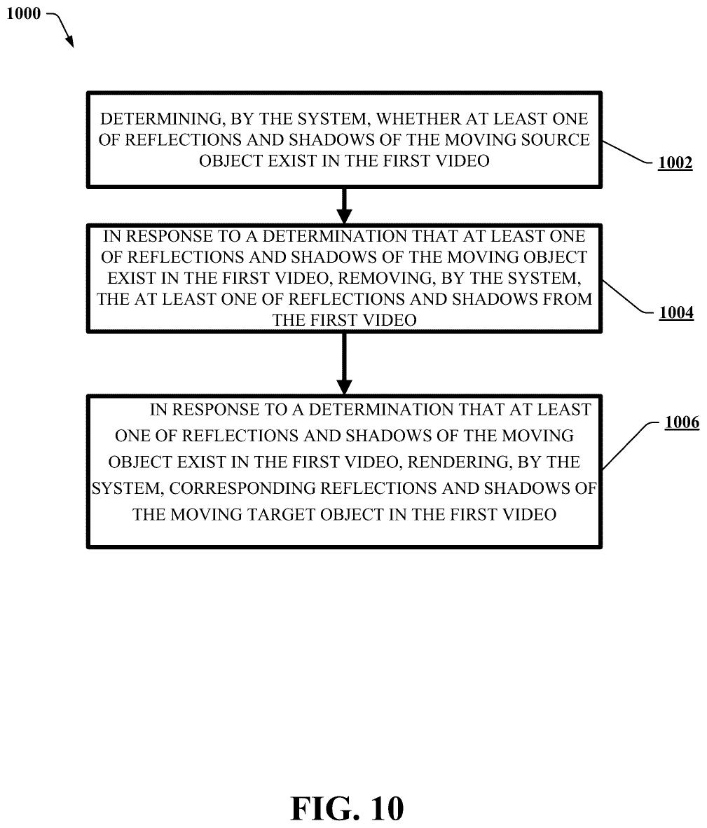

Next, FIG. 10 illustrates a flow diagram of an example, non-limiting method 1000 that can facilitate replacement of a source moving object of a first video with a target moving object of a second video using a GAN, in accordance with one or more embodiments described herein, such as the non-limiting system 200 of FIG. 2. While the non-limiting method 1000 is described relative to the non-limiting system 200 of FIG. 2, the non-limiting method 1000 can be applicable also to other systems described herein, such as the non-limiting system 100 of FIG. 1. Repetitive description of like elements and/or processes employed in respective embodiments is omitted for sake of brevity. At 1002, the non-limiting method 1000 can comprise determining, by a system operably coupled to a processor, (e.g., shadow and reflection extraction component 224) whether at least one of reflections and shadows of the moving source object exist in the first video. At 1004, the non-limiting method 1000 can comprise in response to a determination that at least one of reflections and shadows of the moving object exist in the first video, removing, by the system, (e.g., shadow and reflection extraction component 224) the at least one of reflections and shadows from the first video. At 1006, the non-limiting method 1000 can comprise in response to a determination that at least one of reflections and shadows of the moving object exist in the first video, rendering, by the system, (e.g., shadow and reflection rendering component 226) corresponding reflections and shadows of the moving target object in the first video.

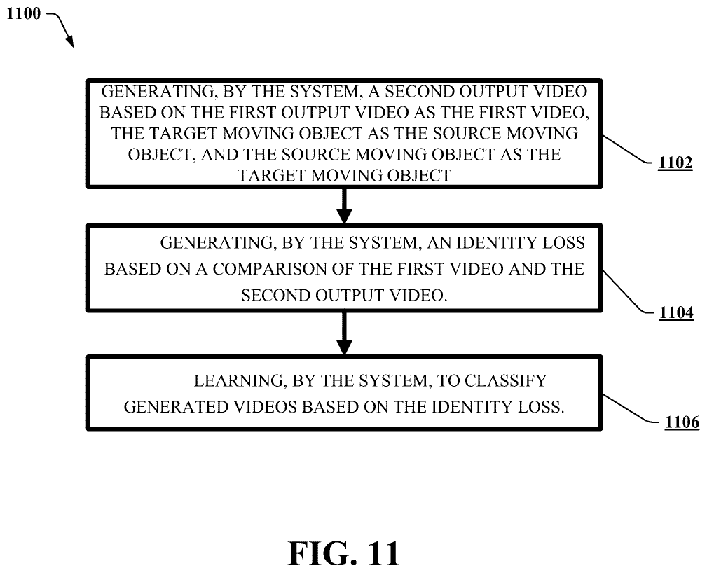

Next, FIG. 11 illustrates a flow diagram of an example, non-limiting method 1100 that can facilitate replacement of a source moving object of a first video with a target moving object of a second video using a GAN, in accordance with one or more embodiments described herein, such as the non-limiting system 200 of FIG. 2. While the non-limiting method 1100 is described relative to the non-limiting system 200 of FIG. 2, the non-limiting method 1100 can be applicable also to other systems described herein, such as the non-limiting system 100 of FIG. 1. Repetitive description of like elements and/or processes employed in respective embodiments is omitted for sake of brevity. At 1102, the non-limiting method 1100 can comprise generating, by a system operably coupled to a processor, (e.g., consistency generator component 228) a second output video based on the first output video as the first video, the target moving object as the source moving object, and the source moving object as the target moving object. At 1104, the non-limiting method 1100 can comprise generating, by the system, (e.g., cycle consistency component 232) an identity loss based on a comparison of the first video and the second output video. At 1106, the non-limiting method 1100 can comprise learning, by the system, (e.g., classification component 114) to classify generated videos based on the identity loss.

Turning next to FIG. 12, a detailed description is provided of additional context for the one or more embodiments described herein at FIGS. 1-11.

FIG. 12 and the following discussion are intended to provide a brief, general description of a suitable computing environment 1200 in which one or more embodiments described herein at FIGS. 1-11 can be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1200 contains an example of an environment for the execution of at least some of the computer code involved in performing the inventive methods, such as object replacement code 1245. In addition to block 1245, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1245, as identified above), peripheral device set 1214 (including user interface (UI), device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1245 in persistent storage 1213.

COMMUNICATION FABRIC 1211 is the signal conduction paths that allow the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, the volatile memory is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid state storage devices. Operating system 1222 may take several forms, such as various known proprietary operating systems or open source Portable Operating System Interface type operating systems that employ a kernel. The code included in block 1245 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1101 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on the user's computer, partly on the user's computer, as a stand-alone software package, partly on the user's computer or partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described herein with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality, and operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function(s). In one or more alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that the one or more embodiments herein also can be implemented in combination with other program modules. Generally, program modules include routines, programs, components, data structures or the like that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics or the like. The illustrated aspects can also be practiced in distributed computing environments in which tasks are performed by remote processing devices that are linked through a communications network. However, some, if not all aspects of the one or more embodiments can be practiced on stand-alone computers. In a distributed computing environment, program modules can be located in both local and remote memory storage devices.

As used in this application, the terms “component,” “system,” “platform,” “interface,” or the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art. As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing the one or more embodiments, but one of ordinary skill in the art can recognize that many further combinations and permutations of the one or more embodiments are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the one or more embodiments provided herein have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory that stores computer executable components; and
a processor that executes computer executable components stored in the memory, wherein the computer executable components comprise:
a generative adversarial network comprising:
a generator component that replaces a moving source object of a first video with a moving target object of a second video to produce an output video; and
a classifier component that classifies the output video as real or fake.

2. The system of claim 1, wherein generator component performs instance segmentation on the first video and the second video produce a segmented moving source object and a segmented moving target object.

3. The system of claim 1, wherein the generator component removes the moving source object from the first video and the moving target source from the second video via a binary mask to generate a masked first video and a removed moving target object.

4. The system of claim 3, wherein the generator component pastes the removed moving target object in the masked first video.

5. The system of claim 1, wherein the classifier component comprises a moving source object classifier and a moving target object classifier.

6. The system of claim 1, further comprising:
a shadow and reflection extraction component that determines whether at least one of a reflection and a shadow of the moving source object exist in the first video, and in response to a determination that at least one of the reflection and the shadow of the moving object exist in the first video, removes the at least one of the reflection and the shadow from the first video.

7. The system of claim 6, further comprising:
a shadow and reflection rendering component that, in response to a determination that at least one of a reflection and a shadow of the moving object exist in the first video, renders corresponding reflections and shadows of the moving target object in the first video.

8. The system of claim 1, further comprising:
a consistency generator component that replaces the moving target object of the output video with a removed moving source object of the first video to produce a consistency output video;
a consistency classifier component that classifies the consistency output video as real or fake; and
a cycle consistency component that compares the first video to the consistency output video to generate a cycle consistency loss.

9. The system of claim 8, wherein the classifier component classifies the output video as real or fake based at least in part on the cycle consistency loss.

10. A computer-implemented method, comprising:
replacing, by a system coupled to a processor, a moving source object of a first video with a moving target object of a second video to produce an output video using a generative adversarial network; and
classifying, by the system, the output video as real or fake.

11. The computer-implemented method of claim 10, further comprising:
performing, by the system, instance segmentation on the first video and the second video produce a segmented moving source object and a segmented moving target object.

12. The computer-implemented method of claim 10, further comprising:
removing, by the system, the moving source object from the first video and the moving target source from the second video via a binary mask to generate a masked first video and a removed moving target object.

13. The computer-implemented method of claim 12, further comprising:
pasting, by the system, the removed moving target object in the masked first video.

14. The computer-implemented method of claim 10, further comprising:
determining, by the system, whether at least one of a reflection and a shadow of the moving source object exist in the first video, and in response to a determination that at least one of the reflection and the shadow of the moving object exist in the first video, removes the at least one of the reflection and the shadow from the first video.

15. The computer-implemented method of claim 14, further comprising:
in response to a determination that at least one of a reflection and a shadow of the moving object exist in the first video, rendering, by the system, corresponding reflections and shadows of the moving target object in the first video.

16. A computer program product facilitating replacement of a source moving object with a target moving object in a video using a generative adversarial network, the computer program product comprising a computer readable storage medium having program instructions embodied therewith, the program instructions executable by a processor to cause the processor to:
replace a moving source object of a first video with a moving target object of a second video to produce an output video; and
classify the output video as real or fake.

17. The computer program product of claim 16, wherein the program instructions are further executable by the processor to cause the processor to:
determine whether at least one of a reflection and a shadow of the moving source object exist in the first video, and in response to a determination that at least one of the reflection and the shadow of the moving object exist in the first video, removes the at least one of the reflection and the shadow from the first video.

18. The computer program product of claim 17, wherein the program instructions are further executable by the processor to cause the processor to:
in response to a determination that at least one of a reflection and a shadow of the moving object exist in the first video, render corresponding reflections and shadows of the moving target object in the first video.

19. The computer program product of claim 17, wherein the program instructions are further executable by the processor to cause the processor to:
replace the moving target object of the output video with a removed moving source object of the first video to produce a consistency output video;
classify the consistency output video as real or fake; and
compare the first video to the consistency output video to generate a cycle consistency loss.

20. The computer program product of claim 19, wherein the program instructions are further executable by the processor to cause the processor to:
classify the output video as real or fake based at least in part on the cycle consistency loss.
